(19) United States
(12) Patent Application Publication
(10) Pub. No.: US 2026/0219634 A1
(43) Pub. Date: Jul. 30, 2026

(54) Bi-Directional Waveguide Coupling

(71) Applicant: Envisics Ltd, Milton Keynes (GB)

(72) Inventor: Alexander Cole, Milton Keynes (GB)

(21) Appl. No.: 19/451,130

(22) Filed: Jan. 16, 2026

(30) Foreign Application Priority Data
Jan. 24, 2025 (GB) 2501032.3
Jan. 24, 2025 (GB) 2501044.8

(51) Int. Cl. G03H 1/22; G02B 27/00; G02B 27/01; G03H 1/02

(52) U.S. Cl. CPC G03H 1/2205; G02B 27/0081; G02B 27/0103; G02B 2027/0145; G03H 2001/0212; G03H 2001/0224; G03H 2001/2239; G03H 2222/34; G03H 2222/53; G03H 2223/16; G03H 2223/23

(57) ABSTRACT

Disclosed optical system embodiments comprise: a waveguide; a spatial light modulator; a first optical element configured to illuminate the spatial light modulator at a first angle of illumination to produce a first wavefront; and a second optical element configured to illuminate the spatial light modulator at a second angle of illumination to produce a second wavefront. The waveguide comprises: a pair of opposing surfaces arranged to guide light therebetween by internal reflection; and an input port. The waveguide is configured to: receive the first wavefront at the input port at a first angle of incidence; receive the second wavefront at the input port at a second angle of incidence opposite in direction to the first angle of incidence; replicate the first wavefront along a first dimension in a first direction; and replicate the second wavefront along the same dimension in an opposite direction.

### CROSS-REFERENCE TO RELATED APPLICATIONS

This application claims priority under 35 U.S.C. § 119 to both (i) UK Pat. App. GB 2501032.3 titled “Bi-directional waveguide coupling,” filed on Jan. 24, 2025, and currently pending; and (ii) UK Pat. App. GB 2501044.8 titled “Chromatic waveguide output coupling compensation,” filed on Jan. 24, 2025, and currently pending. The entire contents of GB 2501032.3 and GB 2501044.8 are incorporated by reference herein for all purposes.

### FIELD

The present disclosure relates to coupling light into a waveguide. More specifically, the present disclosure relates to an optical system comprising a waveguide wavefront replicator and to a method of wavefront replication using a waveguide. The optical system may illuminate a spatial light modulator with two optical elements at different angles of incidence. The waveguide may replicate two incident wavefronts in opposite directions based on the two wavefronts having opposite angles of incidence at the waveguide input port.

### INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

In previous holographic HUD systems, a spatial light modulator, SLM, may be illuminated by a single light source (or multiple light sources, e.g. lasers, of different colours) in order to encode the light with a hologram displayed on the SLM. The light may then be coupled into a first waveguide in order to replicate wavefront along a first dimension and then into a second waveguide to replicate the wavefront in a second dimension. In these previous systems, the light is coupled into the first waveguide at a distal end of the first waveguide, wherein the first waveguide comprises a pair of opposing surfaces: a reflective surface and a transmissive-reflective surface, such that a wavefront propagates along the length of the waveguide while bouncing between these surfaces, outputting a replica at each bounce at the transmissive-reflective surface.

It has been found to be beneficial to couple light into the center of the first waveguide rather than at a distal end of the waveguide. Such a pupil expander may comprise a waveguide arranged to receive an input light field (or pupil) at or near its center and to provide pupil expansion/replication in two opposite directions of the dimension of pupil expansion. Since pupil expansion occurs in two opposite directions, the maximum size of the replicas of the wavefront in each direction is reduced in comparison to pupil expansion in a single direction. Thus, a more compact and lightweight system for pupil expansion is possible.

In order to propagate the input light field in two opposite directions, it has previously been suggested that an input port of the waveguide may comprise a diffractive structure arranged to receive an input light field (or pupil) and to direct or redirect (e.g., diffract) light into first and second orders. The first order (of light) is coupled into the waveguide at a first input angle. The first input angle may fall within a range of input angles for waveguiding light in a first direction of the first dimension. The second order (of light) is coupled into the waveguide at a second input angle. The second input angle may fall within a range of input angles for waveguiding light in a second direction, opposite to the first direction, of the first dimension. It may be said that diffractive structure is arranged to turn (or change the direction of) the received light field of at least one of the first and second orders.

However, the use of a diffractive structure to propagate light in opposite directions may be problematic due to the wavelength-dependence of the diffractive turn. In other words, this can be problematic as different colours diffract at different angles resulting in different propagation paths in the waveguide (i.e. non-achromatic).

The present disclosure provides an alternative approach to central coupling into a waveguide that does not require an input diffractive structure.

Firstly, the present disclosure provides two illumination sources to illuminate the SLM at corresponding angles of illumination. Advantageously, the two wavefronts provided by two illumination sources share the same SLM and subsequent optics (e.g. 4f lens system), such that the illumination intensity of the SLM may be doubled without requiring a second SLM which is typically one of the most expensive and complex components in a holographic projection system. The angle of illumination for a given light source is configured to set a desired angle of incidence at the input port of the waveguide. The angle of incidence at the waveguide for each of the two illumination sources then determines how the respective wavefronts propagate along the length of the waveguide by internal reflection. Central coupling of a spatially modulated wavefront is therefore provided without the use of an input coupling grating or other diffractive structure (e.g. hologram/complex diffractive structure) that may provide unwanted chromatic dispersion.

Secondly, each of the two illumination sources may comprise a number of different sources corresponding to different colour light (i.e. each source may emit a different wavelength of light). For example, an illumination source may comprise a series of light sources such as lasers, e.g. a red laser, a green laser, and a blue laser. Each of these light sources may be angled relative to one another such that each illuminates the SLM at a slightly different angle. The different illumination angles for each different colour light source results in different angles of incidence at the waveguide input port for each colour. The waveguide may comprise an output diffractive element that is used to turn the light output from the waveguide. This output diffractive element may similarly cause unwanted chromatic dispersion which turns the output light by a different amount depending on the wavelength. Advantageously, the angles of illumination and corresponding angles of incidence for each colour light source may be chosen to counteract the chromatic diffractive turn of the output diffractive element such that the different wavelength components exiting the waveguide are substantially parallel (rather than diverging from one another). In other words, the angle of illumination for each wavelength is configured to control the angle of incidence and subsequently the angle at which the light is incident upon the output surface of the waveguide. For instance, if one wavelength component is turned more by the output diffractive element then the angle of illumination for that wavelength component may be configured so that the wavelength component is incident upon the output surface at a greater angle compared to another wavelength component that is turned less by the output diffractive structure. Therefore, the different wavelength components may exit the waveguide at substantially the same angle, i.e. substantially parallel to one another.

The disclosed approach therefore provides an additional degree of freedom regarding in-coupling angles for each colour as defined by the respective SLM illumination angles.

According to a first aspect of the disclosure, there is provided an optical system. The optical system may also be understood as a head-up display, a holographic projector, a wavefront replicator system, or the like. The optical system comprises a waveguide. The waveguide comprises a pair of opposing surfaces arranged to guide light therebetween by internal reflection. For example, the opposing surfaces of the waveguide may comprise a reflective surface and a transmissive-reflective surface that reflects a portion of the light and transmits a portion of the light, such that a plurality of replica wavefronts may be output from the transmissive-reflective surface. The waveguide comprises an input port arranged to receive light. For example, the input port may comprise a substantially or partially transparent window in a reflective surface of the waveguide. In other embodiments, the input port may comprise a substantially or partially transparent window in a reflective-transmissive surface of the waveguide. In examples, the input port may be positioned in the center of the waveguide in an elongate direction of the waveguide. The optical system comprises a spatial light modulator configured to display a light modulation pattern. For example, the light modulation pattern may be a hologram, e.g. a phase-only hologram. For example, the spatial light modulator may be a liquid crystal on silicon (LCoS) device. The optical system comprises a first optical element configured to illuminate the spatial light modulator at a first angle of illumination to produce a first wavefront. For example, the first optical element may be a light source, e.g. a laser diode. The first angle of illumination may be understood, for example, as an angle between the direction of propagation of the first wavefront and a normal to the surface of the spatial light modulator. The first wavefront may, for example, be a holographic wavefront whereby the light from the first optical element is encoded with a hologram displayed on the spatial light modulator. The optical system comprises a second optical element configured to illuminate the spatial light modulator at a second angle of illumination to produce a second wavefront. The second wavefront may, for example, be a holographic wavefront whereby the light from the second optical element is encoded with a hologram displayed on the spatial light modulator. For example, the second optical element may be a light source, e.g. a laser diode. The second angle of illumination may be understood, for example, as an angle between the direction of propagation of the second wavefront and a normal to the surface of the spatial light modulator. In other words, the first and second optical elements illuminate the same light modulation pattern displayed on the spatial light modulator. Alternatively, one of the first and second optical elements may be an arrangement of lenses and/or mirrors configured to provide a portion of light from a shared light source. In other words, one light source may be arranged (e.g. with a beamsplitter) to illuminate the spatial light modulator with two beams at different angles of illumination to produce the first and second wavefronts. The waveguide is configured to receive the first wavefront at the input port at a first angle of incidence. In other words, the first wavefront propagates from the spatial light modulator (e.g. via additional optics such as a 4f lens system) and is incident upon the input port at an angle, e.g. relative to the surface normal of the input port. The waveguide is configured to receive the second wavefront at the input port at a second angle of incidence. In other words, the second wavefront propagates from the spatial light modulator (e.g. via additional optics such as a 4f lens system) and is incident upon the input port at an angle, e.g. relative to the surface normal of the input port. The first angle of incidence is opposite in direction to the second angle of incidence. In other words, the first and second angles of incidence may have substantially the same magnitude but opposite sign, e.g. when measured relative to the surface normal of the input port in a plane defined by the surface normal of the input port and an elongate direction of the waveguide. The waveguide is configured to replicate the first wavefront along a first dimension in a first direction. For example, the first dimension may be defined in terms of an elongate axis of the waveguide. In other words, the waveguide may have an elongate “rod” shape such that the first dimension is the elongate of the waveguide. The waveguide is configured to replicate the second wavefront along the first dimension in a second direction in the first dimension, wherein the first direction is opposite to the second direction in the first dimension. In other words, the first and second wavefronts are replicated along the same elongate dimension of the waveguide, but in opposite directions to one another. For example, the input port may be in the center of the waveguide in the elongate direction, and the first and second wavefronts are replicated in opposite directions from the center of the waveguide.

The first aspect of the disclosure provides a number of technical advantages that would not have been obvious to the skilled person. For example, when considering ways to centrally couple a light field into a waveguide, the skilled person would not find it obvious to depart from previous approaches such as using diffractive input gratings or using two SLMs. In other words, it would not have been obvious to the skilled person to illuminate the same SLM from two different angles in order to achieve different angles of incidence at the waveguide input port.

The input port may not comprise a diffractive element. In other words, the input port may not have a diffractive element coupled to it or placed directly optically upstream from it. It may be said that the input port is non-diffractive.

The first angle of illumination may be substantially equal to the first angle of incidence, and the second angle of illumination may be substantially equal to the second angle of incidence. In other words, there may be a direct correspondence between the respective angles of incidence and the angles of illumination.

The first optical element may comprise a first collimating optics configured to illuminate the spatial light modulator with collimated light at the first angle of illumination. For example, the first collimating optics may comprise one or more collimating lenses. In other words, the collimating optics may be configured to reduce the divergence of light from a light source.

The second optical element may comprise a second collimating optics configured to illuminate the spatial light modulator with collimated light at the second angle of illumination. For example, the second collimating optics may comprise one or more collimating lenses.

The optical system may further comprise a first lens with a first focal length, wherein the spatial light modulator may be positioned at a first focal plane of the first lens. In other words, the first lens may have two focal planes: one optically upstream and one optically downstream. The spatial light modulator may be positioned at the upstream focal plane of the first lens. A plane of the spatial light modulator may be aligned with the upstream focal plane of the first lens.

The optical system may further comprise a second lens with a second focal length, wherein a first focal plane of the second lens may be positioned to substantially overlap a second focal plane of the first lens, and wherein the input port of the waveguide may be positioned proximate to a second focal plane of the second lens. In other words, the second lens may also have two focal planes as with the first lens. The first lens and second lens may be identical to one another and thus have substantially the same focal length. Alternatively, the first lens and second lens may have different focal lengths. The second downstream focal plane of the second lens may be proximate to the input port in that it may be either at the surface of the waveguide or slightly inside the waveguide or slightly outside the waveguide. In other words, the first and second lenses form a 4f lens system.

The first lens may be configured to receive the first wavefront and to produce a first intermediate image at the second focal plane of the first lens, and the first lens may be further configured to receive the second wavefront and to produce a second intermediate image at the second focal plane of the first lens. In other words, the first lens may be considered as performing a Fourier transform of the first wavefront to transform the first wavefront from the frequency/hologram domain to the spatial/image domain. The overlapping focal planes of the first and second lenses may be referred to as the Fourier plane of a 4f system formed by the two lenses.

The first intermediate image and the second intermediate image may be spatially separated from one another. In other words, there is no overlap between the intermediate images (i.e. in the spatial domain).

The optical system may further comprise an output diffractive structure associated with an output port of the waveguide and configured to receive the replicated first wavefronts and replicated second wavefronts. In examples, the output diffractive structure may be employed in order to apply a turn to the light being output from the waveguide. The output diffractive structure may apply a chromatic (i.e. wavelength dependent) dispersion to the wavefronts.

The output diffractive structure may comprise a first section configured to receive the replicated first wavefronts, and a second section configured to receive the replicated second wavefronts. The first section may form half of the structure, and the second section may form the other half of the structure. For example, the first section may be formed on the waveguide on one side of the input port (e.g. in the center of the waveguide) and the second section may be formed on the waveguide on the opposite side of the input port.

Each of the first optical element and second optical element may further comprise: a first light source configured to emit a first wavelength of light, and a second light source configured to emit a second wavelength of light. For example, the light sources may be laser diodes. By way of example only, the first/second wavelengths may each be one of red, green, or blue wavelengths.

The first light source may be configured to illuminate the spatial light modulator at a first source angle of illumination and the second light source is configured to illuminate the spatial light modulator at a second source angle of illumination different to the first source angle of illumination. A source angle of illumination may be understood as the angle at which each light source of the respective optical element illuminates the spatial light modulator. In other words, for a given one of the first/second optical elements, each light source has a different angle of illumination. One of the light sources may have an angle of illumination the same as the respective “overall” optical element, and other light sources of that optical element may have an angle of illumination offset from this angle.

The first wavefront may comprise a first sub-wavefront corresponding to the first light source and a second sub-wavefront corresponding to the second light source, wherein the first sub-wavefront may be received at the input port of the waveguide at a different angle of incidence than the second sub-wavefront. In other words, the first wavefront is made up of the individual wavefronts (sub-wavefronts) produced by the light sources of the respective optical element.

Each of the first optical element and second optical element may comprise: a first collimating lens configured to illuminate the spatial light modulator with collimated light from the first light source at the first source angle of illumination; and a second collimating lens configured to illuminate the spatial light modulator with collimated light from the second light source at the second source angle of illumination. In other words, each of the individual light sources may have a corresponding collimation lens to collimate light from that light source.

The optical system may comprise an output diffractive structure associated with an output port of the waveguide, wherein the angle of incidence of the first sub-wavefront corresponding to the first wavelength and the angle of incidence of the second sub-wavefront corresponding to the second wavelength are selected to counteract a difference in diffractive turn angle provided by the output diffractive structure to the first sub-wavefront and the second sub-wavefront. As described above, the output diffractive structure may diffract different wavelengths at different diffraction angles. By providing different wavelength components at different angles of incidence, the components impinge on the output diffractive structure at different angles. These different angles are selected to counteract the amount of diffraction applied by the output diffractive structure, so that the output wavelength components are substantially parallel to one another. In some embodiments, the difference in output angles of the wavelength components is reduced.

The spatial light modulator may be either transmissive or reflective.

According to a second aspect of the disclosure, there is provided a method for holographic projection. The method comprises illuminating a spatial light modulator with a first optical element at a first angle of illumination to form a first wavefront. The method comprises illuminating the spatial light modulator with a second optical element at a second angle of illumination to form a second wavefront. The method comprises coupling the first wavefront into a waveguide at a first angle of incidence. The method comprises coupling the second wavefront into the waveguide at a second angle of incidence, wherein the first angle of incidence is opposite in direction to the second angle of incidence. The method comprises replicating the first wavefront along a first dimension of the waveguide in a first direction. The method comprises replicating the second wavefront along the first dimension of the waveguide in a second direction, the first direction being opposite to the second direction.

According to a third aspect of the disclosure, there is provided an optical system. The optical system may also be understood as a head-up display, a holographic projector, a wavefront replicator system, or the like. The optical system comprises a waveguide. The waveguide comprises a pair of opposing surfaces arranged to guide light therebetween by internal reflection. For example, the opposing surfaces of the waveguide may comprise a reflective surface and a transmissive-reflective surface that reflects a portion of the light and transmits a portion of the light, such that a plurality of replica wavefronts may be output from the transmissive-reflective surface. The waveguide comprises an input port arranged to receive light. For example, the input port may comprise a substantially or partially transparent window in a reflective surface of the waveguide. In other embodiments, the input port may comprise a substantially or partially transparent window in a reflective-transmissive surface of the waveguide. In examples, the input port may be positioned in the center of the waveguide in an elongate direction of the waveguide. The optical system comprises a spatial light modulator configured to display a light modulation pattern. For example, the light modulation pattern may be a hologram, e.g. a phase-only hologram. For example, the spatial light modulator may be a liquid crystal on silicon (LCoS) device. The optical system comprises a first light source configured to output a first wavelength of light and configured to illuminate the spatial light modulator at a first angle of illumination to form a first wavefront. For example, the first light source may be a laser diode. The first angle of illumination may be understood, for example, as an angle between the direction of propagation of the first wavefront and a normal to the surface of the spatial light modulator. The first wavefront may, for example, be a holographic wavefront whereby the light from the first optical element is encoded with a hologram displayed on the spatial light modulator. The optical system comprises a second light source configured to output a second wavelength of light different to the first wavelength, and configured to illuminate the spatial light modulator at a second angle of illumination different to the first angle of illumination to form a second wavefront. The second wavefront may, for example, be a holographic wavefront whereby the light from the second light source is encoded with a hologram displayed on the spatial light modulator. For example, the second light source may be a laser diode. The second angle of illumination may be understood, for example, as an angle between the direction of propagation of the second wavefront and a normal to the surface of the spatial light modulator. In other words, the first and second light sources illuminate the same light modulation pattern displayed on the spatial light modulator. The optical system comprises an output diffractive structure coupled to an output surface of the waveguide. For example, the output diffractive structure may be associated with an output port of the waveguide. In examples, the output diffractive structure may be employed in order to apply a turn to the light being output from the waveguide. The output diffractive structure may apply a chromatic (i.e. wavelength dependent) dispersion to the wavefronts. The waveguide is configured to receive the first wavefront at the input port at a first angle of incidence. In other words, the first wavefront propagates from the spatial light modulator (e.g. via additional optics such as a 4f lens system) and is incident upon the input port at an angle, e.g. relative to the surface normal of the input port. The waveguide is configured to receive the second wavefront at the input port at a second angle of incidence. In other words, the second wavefront propagates from the spatial light modulator (e.g. via additional optics such as a 4f lens system) and is incident upon the input port at an angle, e.g. relative to the surface normal of the input port. The first angle of incidence and the second angle of incidence have a different magnitude. In other words, the first and second wavefronts may angled in a same direction relative to the waveguide, but be angled differently to one another. For example, the first and second wavefronts may both have a vector component aligned with an elongate direction of the waveguide, but this component has a different value in each of the first and second wavefronts. The waveguide is configured to replicate the first wavefront along a first dimension in a first direction. For example, the first dimension may be defined in terms of an elongate axis of the waveguide. In other words, the waveguide may have an elongate “rod” shape such that the first dimension is the elongate of the waveguide. The waveguide is configured to replicate the second wavefront along the first dimension in the first direction wherein the first wavefront and replicas thereof and the second wavefront and replicas thereof are coupled out of the waveguide via the output diffractive structure. In other words, the first and second wavefronts are replicated along the same dimension and in the same direction of the waveguide, and are both output via the output diffractive structure. For example, the input port may be in the center of the waveguide in the elongate direction, and the first and second wavefronts are replicated in the same direction from the center of the waveguide.

The third aspect of the disclosure provides a number of technical advantages. For example, when considering ways to centrally couple a light field into a waveguide, the skilled person would not find it obvious to depart from previous approaches such as using diffractive input gratings. Furthermore, the skilled person would not have found it obvious to angle light sources relative to one another such that different wavelengths of light are coupled into the waveguide at different angles of incidence. As the skilled person can appreciate, the angles of illumination and corresponding angles of incidence for each colour light source may be chosen to counteract the chromatic diffractive turn of the output diffractive element such that the different wavelength components exiting the waveguide are substantially parallel (rather than diverging from one another). In other words, the angle of illumination for each wavelength is configured to control the angle of incidence and subsequently the angle at which the light is incident upon the output surface of the waveguide. For instance, if one wavelength component is turned more by the output diffractive element then the angle of illumination for that wavelength component may be configured so that the wavelength component is incident upon the output surface at a greater angle compared to another wavelength component that is turned less by the output diffractive structure. Therefore, the different wavelength components may exit the waveguide at substantially the same angle, i.e. substantially parallel to one another.

The input port may not comprise a diffractive element. In other words, the input port may not have a diffractive element coupled to it or placed directly optically upstream from it. It may be said that the input port is non-diffractive.

The output diffractive structure may be configured to perform a diffractive turn of the first wavefront and replicas thereof and the second wavefront and replicas thereof. In other words, since the first wavefront and replicas thereof have a different wavelength to the second wavefront and replicas thereof, the output diffractive structure may apply a different degree of diffractive turn depending on the wavelength of the light.

The first angle of illumination and second angle of illumination may respectively determine the first angle of incidence and the second angle of incidence. In other words, the respective angles of illumination are directly linked to the angles of incidence and may for example have a 1:1 correspondence.

The first angle of incidence and the second angle of incidence may be configured to counteract a difference in diffractive turn angle provided by the output diffractive structure to the first wavefront and replicas thereof and the second wavefront and replicas thereof. As described above, the output diffractive structure may diffract different wavelengths at different diffraction angles. By providing different wavelength components at different angles of incidence, the components impinge on the output diffractive structure at different angles. These different angles are selected to counteract the amount of diffraction applied by the output diffractive structure, so that the output wavelength components are substantially parallel to one another. In some embodiments, the difference in output angles of the wavelength components is reduced.

The first wavefront and replicas thereof and the second wavefront and replicas thereof output from the output diffractive structure may be substantially parallel to one another. In other words, the difference in angles of incidence substantially or exactly compensates for the difference in the degree of diffractive turn for each wavelength.

The optical system may further comprise a first collimating lens configured to receive light emitted from the first light source and to illuminate the spatial light modulator with collimated light at the first angle of illumination. In other words, the first collimating lens may be configured to reduce the divergence of light from the first light source.

The optical system may further comprise a second collimating lens configured to receive light emitted from the second light source and to illuminate the spatial light modulator with collimated light at the second angle of illumination. In other words, the second collimating lens may be configured to reduce the divergence of light from the second light source.

The optical system may further comprise a first lens with a first focal length, wherein the spatial light modulator is positioned at a first focal plane of the first lens. In other words, the first lens may have two focal planes: one optically upstream and one optically downstream. The spatial light modulator may be positioned at the upstream focal plane of the first lens. A plane of the spatial light modulator may be aligned with the upstream focal plane of the first lens.

The optical system may further comprise a second lens with a second focal length, wherein a first focal plane of the second lens may be positioned to overlap a second focal plane of the first lens, and wherein the input port of the waveguide may be positioned proximate to a second focal plane of the second lens. In other words, the second lens may also have two focal planes as with the first lens. The first lens and second lens may be identical to one another and thus have the same focal length. Alternatively, the first lens and second lens may have different focal lengths. The second downstream focal plane of the second lens may be proximate to the input port in that it may be either at the surface of the waveguide or slightly inside the waveguide or slightly outside the waveguide. In other words, the first and second lenses form a 4f lens system.

The optical system may further comprise a third light source configured to output a third wavelength of light different to the first wavelength and second wavelength, and configured to illuminate the spatial light modulator at a third angle of illumination different to the first angle of illumination and second angle of illumination to form a third wavefront, wherein the waveguide is configured to receive the third wavefront at the input port at a third angle of incidence, wherein the third angle of incidence has a different magnitude to the first angle of incidence and the second angle of incidence. In some embodiments, the first, second and third light sources collectively form a first set of light sources. The first, second and third wavelengths may, for example, be red, green, and blue wavelengths, and may enable full colour holographic projection.

The optical system may further comprise a fourth light source configured to output the first wavelength of light, and configured to illuminate the spatial light modulator at a fourth angle of illumination equal in magnitude and opposite in direction to the first angle of illumination. In other words, the fourth light source is a “mirror image” of the first light source in that it outputs the same wavelength of light at the same magnitude angle, but from an opposite direction (e.g. has an opposite vector component in the elongate direction of the waveguide).

The optical system may further comprise a fifth light source configured to output the second wavelength of light, and configured to illuminate the spatial light modulator at a fifth angle of illumination equal in magnitude and opposite in direction to the second angle of illumination. In other words, the fifth light source is a “mirror image” of the second light source in that it outputs the same wavelength of light at the same magnitude angle, but from an opposite direction (e.g. has an opposite vector component in the elongate direction of the waveguide).

The optical system may further comprise a sixth light source configured to output the third wavelength of light, and configured to illuminate the spatial light modulator at a sixth angle of illumination equal in magnitude and opposite in direction to the third angle of illumination. In other words, the sixth light source is a “mirror image” of the third light source in that it outputs the same wavelength of light at the same magnitude angle, but from an opposite direction (e.g. has an opposite vector component in the elongate direction of the waveguide). In some embodiments, the fourth, fifth and sixth light sources may collectively form a second set of light sources.

The fourth, fifth and sixth light sources may respectively form fourth, fifth and sixth wavefronts that are coupled into the waveguide and fourth, fifth and sixth angles of incidence, and that are replicated along the first dimension of the waveguide, but in an opposite direction to the first, second and third wavefronts.

The spatial light modulator may be either transmissive or reflective.

According to a fourth aspect of the disclosure, there is provided a method for holographic projection. The method comprises illuminating a spatial light modulator with a first light source at a first wavelength and at a first angle of illumination to form a first wavefront. The method comprises illuminating the spatial light modulator with a second light source at a second wavelength and at a second angle of illumination different to the first angle of illumination to form a second wavefront. The method comprises coupling the first wavefront into a waveguide at a first angle of incidence. The method comprises coupling the second wavefront into the waveguide at a second angle of incidence, wherein the first angle of incidence and the second angle of incidence have a different magnitude. The method comprises replicating the first wavefront along a first dimension of the waveguide in a first direction. The method comprises replicating the second wavefront along the first dimension of the waveguide in the first direction. The method comprises coupling the first wavefront and replicas thereof and the second wavefront and replicas thereof out of the waveguide via an output diffractive structure.

The method may comprise performing a diffractive turn of the first wavefront and replicas thereof and the second wavefront and replicas thereof with the output diffractive structure.

The method may comprise configuring the first angle of incidence and the second angle of incidence to counteract a difference in diffractive turn angle provided by the output diffractive structure to the first wavefront and replicas thereof and the second wavefront and replicas thereof.

The first wavefront and replicas thereof and the second wavefront and replicas thereof output from the output diffractive structure may be substantially parallel to one another.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances—providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels - that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander comprising two replicators each in the form of a solid waveguide;

FIG. 6 is a side view of an elongate waveguide replicator for pupil expansion of a diverging input light field in a first dimension showing the optical footprint at the output surface in accordance with an example;

FIG. 7 is a side view of an elongate waveguide replicator for pupil expansion of a diverging input light field in a first dimension showing the optical footprint at the output surface in accordance with the present disclosure;

FIG. 8 is a top view of an elongate waveguide replicator for pupil expansion of first and second input light fields in opposite directions of a first dimension in accordance with an example;

FIG. 9 is a top view of an elongate waveguide replicator for pupil expansion of an input light field in opposite directions of a first dimension in accordance with the present disclosure;

FIG. 10 shows a schematic view of a dual-illumination optical system for central launch into a waveguide, according to the present disclosure.

FIG. 11 shows the coupling of two wavefronts into a central input port of a waveguide, and the propagation of the two wavefronts in opposite directions of the waveguide.

FIG. 12 shows the effect of chromatic dispersion associated with the diffractive turn of an output diffractive element.

FIG. 13 shows an embodiment of the present disclosure whereby each of the two illumination sources may comprise a number of different sources corresponding to different colour light.

FIG. 14 shows three wavefronts resulting from illumination of a spatial light modulator by a set of three light sources at different angles of illumination/incidence.

The same reference numbers will be used throughout the drawings to refer to the same or like parts.

### DETAILED DESCRIPTION

The present disclosure is not restricted to the embodiments described in the following but extends to the full scope of the appended claims. That is, the present disclosure may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship-for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

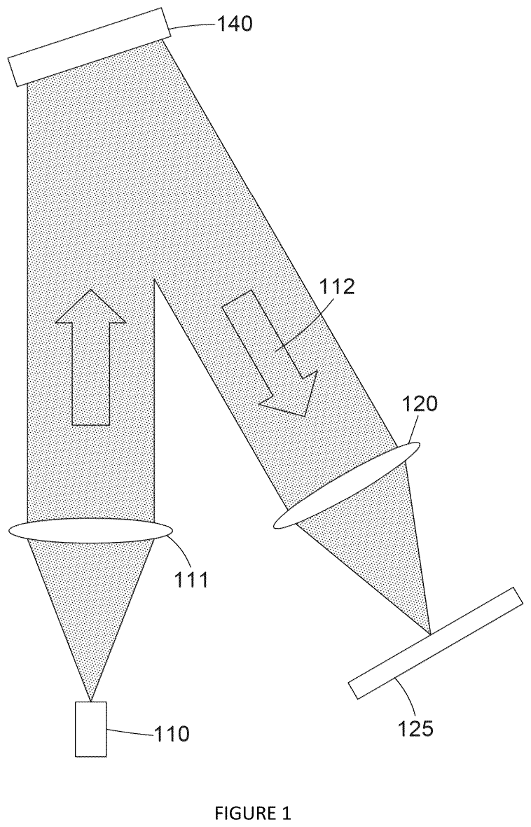

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram-is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device - that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some arrangements, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Modulation

The display system comprises a display device which in embodiments defines the exit pupil of the display system. The display device is a spatial light modulator. The spatial light modulation may be a phase modulator. The display device may be a liquid crystal on silicon, “LCOS”, spatial light modulator.

### Light Channelling

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

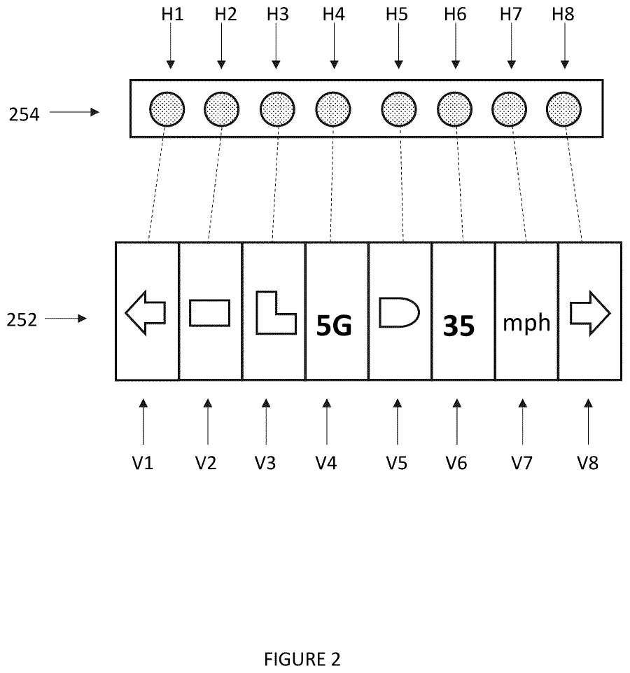

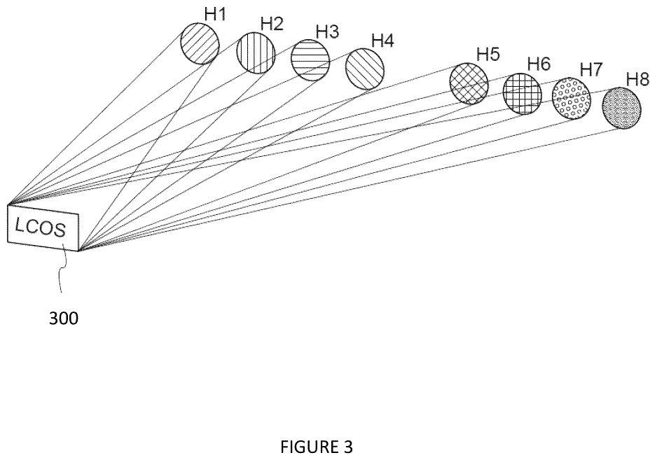

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

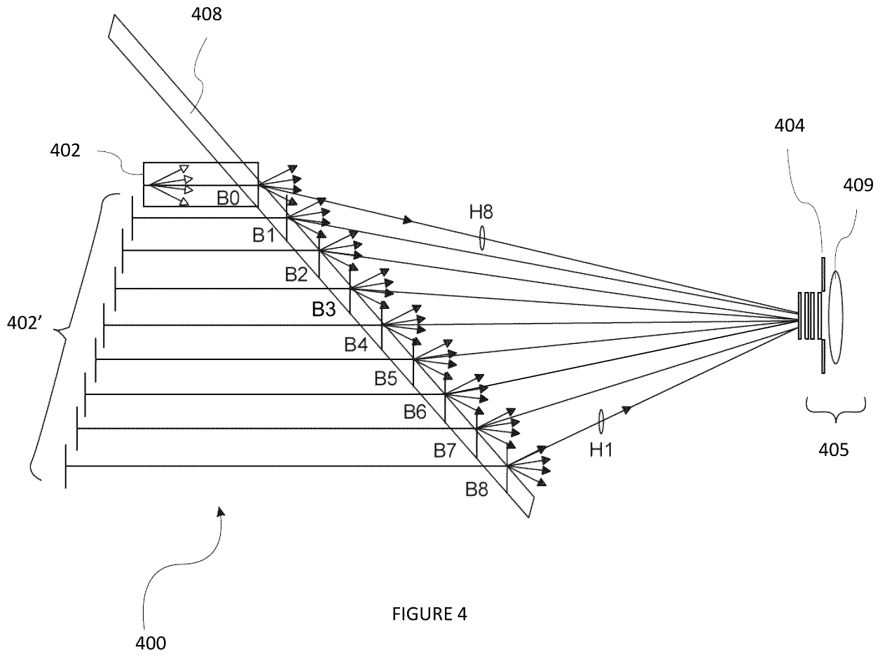

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

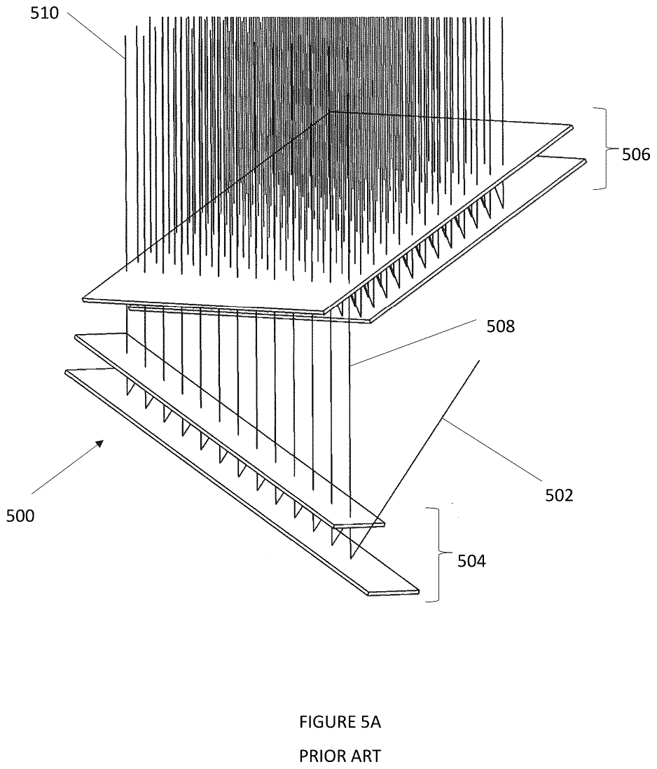

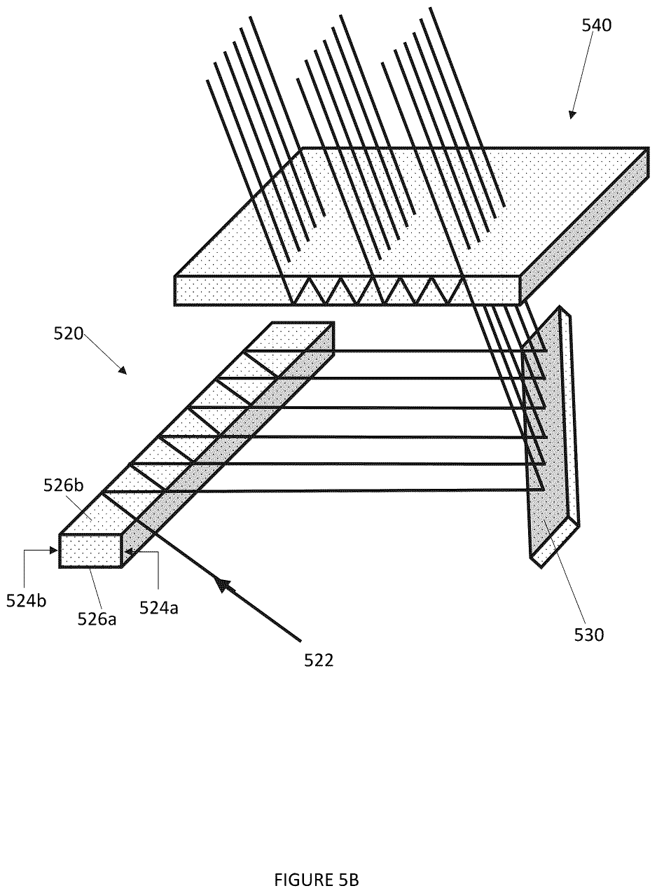

The waveguide 408 forms a plurality of replicas of the hologram, at the respective “bounce” points B1 to B8 along its length, corresponding to the direction of pupil expansion. As shown in FIG. 5, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light—comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device—such as a pixelated display device, for example a spatial light modulator (SLM) or Liquid Crystal on Silicon (LCoS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM—determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extent by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field—including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European U.S. Pat. No. 2,936,252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European U.S. Pat. No. 2,936,252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the deliver of hologram light channels, and their replicas, to the eye-box. Each aperture or window may comprise a plurality of liquid crystal cells or pixels.

### One-dimensional Pupil Expansion of Diverging Light

In some implementations, light coupled into the first replicator is diverging. For example, as described herein, the input light may comprise a diffracted light field comprising diverging light ray bundles. For example, a holographic light field comprising spatially modulated light in accordance with a hologram may be coupled into the first replicator (e.g., in a so-called “direct view” system) such that the holographic light field expands with propagation distance. It may be said that the size of the holographic wavefront increases with propagation distance (from and input port) along the first replicator. In another example, the light field or wavefront corresponds to an image or picture formed on a surface such as a diffuse surface.

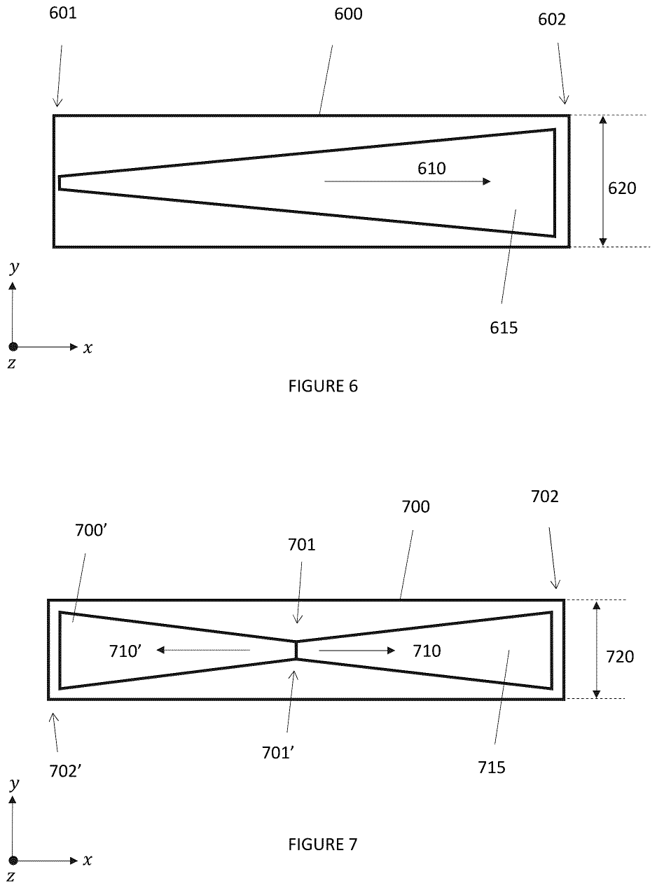

FIG. 6 shows a side view of an example waveguide 600 forming a first replicator for providing pupil expansion of an input light field in a first dimension (illustrated as the x dimension), equivalent to the first replicator 520 of FIG. 5B. In particular, FIG. 6 shows an elongate, quadrilateral output surface of a rod-shaped waveguide 600, equivalent to the reflective-transmissive surface 524a of the first replicator 520 of FIG. 5B, for the output of a one-dimensional array of replicas extending in the first dimension. As the skilled person will appreciate, waveguide 600 also has a corresponding reflective surface, equivalent to the reflective surface 524b of the first replicator 520 of FIG. 5B, having the same elongate, quadrilateral shape. The two reflective surfaces of the waveguide 600 may be arranged in a plane generally extending in the first and second dimensions (illustrated as the x and y dimensions), as in the arrangement of FIG. 5B.

In the illustrated arrangement, an input light field is coupled into the waveguide 600 at an input port (not shown) at a first end 601, and is waveguided between its two reflective surfaces in a first direction of the first dimension towards a second end 602, as shown by arrow 610. A one-dimensional array of replicas of the input light field, extending in the first dimension, are output from the output surface, as described herein. Since the light field is a diffracted light field comprising diverging ray bundles, the size of the wavefront increases with distance from the first end 601 to the second end 602. In consequence, the wavefront of the output replicas also increase in size. FIG. 6 illustrates a boundary of an optical footprint 615 of the replicas output from the output surface. As shown, due to the diverging light ray bundles, the size of the optical footprint 615 increases with distance in the first direction of the first dimension from a smallest size in the second dimension at the first end 601 to a largest size in the second dimension at the second end 602 of waveguide 600. It may be said that the optical footprint 615 tapers outwardly from the first end 601 to the second end 602 of the waveguide 600.

Accordingly, as shown in FIG. 6, a height 620 of the waveguide 600, corresponding to the width of the illustrated output surface in the second dimension (illustrated as the y dimension), must be greater than the maximum size of the optical footprint 615 at the second end 602 of the waveguide 600.

In some applications, the amount of pupil expansion/replication required from the first replicator necessitates a relatively long waveguide in the elongate, dimension of pupil expansion (i.e., the first dimension). Furthermore, depending upon the preferred configuration, the first replicator may need to be tilted in the plane of the first planar layer (i.e., the plane in the first and second dimensions or x-y plane). For example, the longitudinal axis of the first replicator may be at an angle with respect to the first dimension (illustrated as the x dimension), to allow the effective propagation and coupling of replicas output from the first replicator into the second replicator as described in UK patent application publication, GB2610875A. In this tilted configuration, a minimum separation or gap is required between the first planar layer/replicator and second planar layer/replicator. Thus, the required height 620 of the waveguide 600 for the desired amount of pupil expansion, as well as the need for the above described tilt, is a constraint on the overall size of the replicator system, such as the arrangement shown in FIG. 5B. This may mean that the replicator system is too bulky for use in applications where available space is at a premium, such as under the dashboard of a vehicle in an automotive head-up display.

### Central Launch Waveguide for Pupil Expansion of Diverging Light Field

FIG. 7 shows a side view of a waveguide 700 in accordance with an embodiment of the present disclosure. Similar to the above described waveguide 600 of FIG. 6, waveguide 700 forms a first replicator for providing pupil expansion of an input light field in a first dimension (illustrated as the x dimension), equivalent to the first replicator 520 of FIG. 5B. In particular, FIG. 7 shows an elongate, quadrilateral output surface of a rod-shaped waveguide 700, equivalent to the reflective-transmissive surface 524a of the first replicator 520 of FIG. 5B, for the output of a one-dimensional array of replicas extending in the first dimension. As the skilled person will appreciate, waveguide 700 also has a corresponding reflective surface, equivalent to the reflective surface 524b of the first replicator 520 of FIG. 5B, having the same elongate, quadrilateral shape. The two reflective surfaces of the waveguide 700 may be arranged in a plane generally extending in the first and second dimensions (illustrated as the x and y dimensions), as in the arrangement of FIG. 5B.

As shown in FIG. 7, a height 720 of the waveguide 700, corresponding to the width of the illustrated output surface in the second dimension (illustrated as the y dimension), is reduced compared to the height 620 of the waveguide 600 of FIG. 6. This may be achieved by changing the way in which an input light field is coupled into, and waveguided between the two reflective surfaces of, waveguide 700.

In the illustrated embodiment, an input light field is coupled into the waveguide 700 at an input port (not shown) at its centre 701, and is waveguided between its two reflective surfaces in opposite first and second directions of the first dimension towards respective first and second ends 702, 702′, as shown by arrows 710, 710′. A one-dimensional array of replicas of the input light field, extending in the first dimension, are output from the output surface, as described herein. Since the light field is a diffracted light field comprising diverging ray bundles, the size of the wavefront increases with distance from the centre 701 to the first end 702 and from the centre 701′ to the second end 702′. In consequence, the wavefront of the output replicas also increase in size. FIG. 7 illustrates a boundary of first and second optical footprints 715, 715′ of the replicas output from the output surface. As shown, due to the diverging light ray bundles, the size of the first optical footprint 715 increases with distance in the first direction of the first dimension, as illustrated by arrows 710, from a smallest size in the second dimension at the centre 701 to a largest size in the second dimension at the first end 702 of waveguide 700. Similarly, the size of the second optical footprint 715′ increases with distance in the second direction of the first dimension, as illustrated by arrows 710′, from a smaller size in the second dimension at the centre 701′ to a largest size in the second dimension at the second end 702′ of waveguide 700. It may be said that each of the first and second optical footprints 715, 715′ tapers outwardly from the centre 701, 701′ to the respective end 702, 702′ of waveguide 700. In the illustrated arrangement, the first and second optical footprints 715, 715′ are substantially the same, thus providing symmetry in the first and second directions of the first dimension about the centre 701 of waveguide 700.

Since the input light field is coupled into the centre 701 of the waveguide 700 and provides pupil expansion in two opposite, first and second directions of the first dimension, corresponding to the dimension of pupil expansion, the maximum size of the first and second optical footprints 715, 715′ is reduced, in comparison to the arrangement of the waveguide 600 of FIG. 6 when configured for the same amount of pupil expansion. Accordingly, the height 720 of the waveguide 700 of FIG. 7, corresponding to the width of the illustrated output surface in the second dimension (illustrated as the y dimension), is reduced, in comparison to the height 620 of the waveguide 600 of FIG. 6. This may lead to a reduction in the overall size (e.g., height) of a two replicator system, such as that shown in FIG. 5B, and a more compact arrangement for applications in which space is at a premium. In addition, the inventors have found that it is possible to reduce the tilt of the waveguide 700 in the plane of the first planar layer, such as a tilt or angle of the longitudinal axis of waveguide 700 with respect to the first dimension (illustrated as the x dimension). This, in turn, enables a reduction in the gap between the first and second replicators of a two replicator system, further reducing height and contributing to a more compact arrangement.

In the arrangement shown in FIG. 7, a single holographic light field (or pupil) is input into the centre of the waveguide 700, and is waveguided between the two reflective surfaces thereof to provide pupil expansion in opposite, first and second directions of the first dimension. The following description discloses to one a suitable technique for coupling a single light field, for replication across a desired field of view, into the centre of the waveguide 700. As the skilled person will appreciate, other techniques for coupling a single light field (or pupil) into the centre of the waveguide (in the first dimension), described herein as a “central launch” waveguide are possible and contemplated.

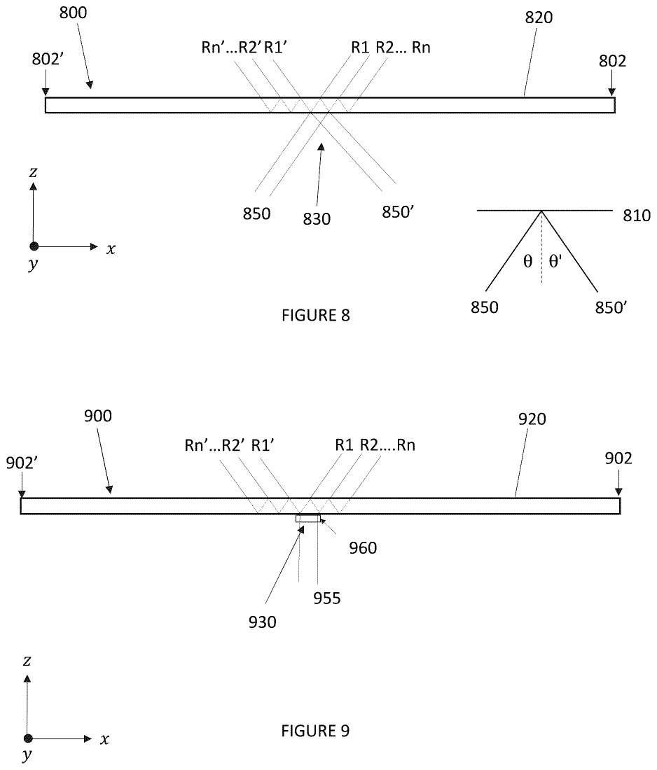

As the skilled person will appreciate, in other implementations, first and second light fields may be coupled into the waveguide 700 at its centre, such that the first light field is waveguided in the first direction of the first dimension, and the second light field is waveguided in the second direction of the first dimension as described below with reference to FIG. 8. In such arrangements, each of the first and second light field corresponds to a respective half of a desired field of view in the first dimension, and is received as an exit pupil from a separate optical system.

### In-coupling of a Diverging Light Field Into “Central Launch” Waveguide

FIG. 8 is a top view of a conventional waveguide 800 for providing pupil expansion in a first dimension, comprising an input port at its centre (in the first dimension). In particular, waveguide 800 comprises an elongate, quadrilateral sided rod-shaped waveguide, which may be used as a first replicator for providing pupil expansion of an input light field in a first dimension (illustrated as the x dimension). Waveguide 800 comprises a reflective surface 810, illustrated as the bottom surface in FIG. 8, and a transmissive-reflective surface 820, illustrated as the top surface in FIG. 8. An input port 830 is provided at the centre in the bottom surface, such as an aperture or gap in the reflective surface 810, and the transmissive-reflective top surface 820 forms an output surface (or output port).

A first light field 850 is incident on the input port 830 of the waveguide 800 at the centre of the waveguide at a first input angle (or angle of incidence) θ and is waveguided between the reflective bottom surface 810 and transmissive-reflective top surface 820 thereof in a first direction of the first dimension. A first one-dimensional array of replicas R1, R2, . . . Rn of the first light field 850, extending in the first direction towards a first end 802 of waveguide 800, are formed and output at the transmissive-reflective output surface 820. The first one-dimensional array of replicas R1, R2, . . . Rn are a first subset, corresponding to about half of the total number of replicas formed by waveguide 800.

Similarly, a second light field 850′, substantially identical to first light field 850, is incident on the input port 830 of the waveguide 800 at a second input angle (or angle of incidence) θ′ and is waveguided between the reflective bottom surface 810 and transmissive-reflective top surface 820 thereof in a second direction, opposite to the first dimension, of the first dimension. A second one-dimensional array of replicas R1′, R2′, . . . Rn′ of the second light field 850′, extending in the second direction towards a second end 802′ of waveguide 800, are formed and output at the transmissive-reflective output surface 820. The second one-dimensional array of replicas R1′, R2′, . . . Rn′ are a second subset, corresponding to about half of the total number of replicas formed by waveguide 800. As the skilled person will appreciate, the first input angle (or angle of incidence) θ is equal in magnitude, and opposite in direction, to the second input angle (or angle of incidence) θ′. Thus, the first and second one-dimensional arrays of replicas formed at the transmissive-reflective output surface 820 of waveguide 800 together form the total number of replicas corresponding to the desired field of view.

FIG. 8 shows just one example of the first and second input angles θ, θ′ of the respective first and second light fields 850, 850′. As the skilled person will appreciate, a waveguide pupil expander 800 comprising an input port at its centre in a first dimension, may be configured to waveguide first light, received at a first range of input angles, in a first direction of the first dimension, and to waveguide second light, received at a second range of input angles, in a second direction, opposite to the first direction, of the first dimension. The first range of input angles is (substantially) equal in magnitude, and opposite in direction, to the second range of input angles.

Accordingly, in a conventional waveguide arranged for in-coupling of light at its centre (in the first dimension of pupil expansion) and providing pupil expansion in opposite directions, it is necessary to provide two separate SLMs and 4f lens systems having respective exit pupils for coupling into the waveguide 800 at different angles. As noted above, each of the two exit pupils represents half the field of view, but, in practice, correspond to the same light field 850 for replication. Thus, the requirement to provide two separate SLMs and 4f lens systems for coupling two separate light fields (i.e., exit pupils) into the waveguide at different input angles increases cost and complexity of the system for pupil expansion. Furthermore, the exit pupils from the two optical systems should be substantially identical, and provided at the same angle of incidence, but in opposite directions. This is challenging due to different tolerances of two physically separate SLM and 4f systems, which may lead to differences in the two light fields (exit pupils) coupled into the waveguide and differences in the magnitude of their respective angles of incidence. The inventors have found that slight differences in the two light fields may lead to poor pupil expansion and image quality, such as poor image uniformity across the complete field of view.

FIG. 9 is a top view of a waveguide 900 for providing pupil expansion in a first dimension, comprising an input port at its centre (in the first dimension), in accordance a comparative example of the disclosure. Similar to the waveguide 800 of FIG. 8, waveguide 900 comprises an elongate, quadrilateral sided rod-shaped waveguide, which may be used as a first replicator for providing pupil expansion of an input light field in a first dimension (illustrated as the x dimension). Waveguide 900 comprises a reflective surface 910, illustrated as the bottom surface in FIG. 9, and a transmissive-reflective surface 920, illustrated as the top surface in FIG. 9. Similar to the waveguide 800 of FIG. 8, the transmissive-reflective top surface 920 forms an output surface (or output port). However, the input port 930 at the centre of the bottom surface 910 of the waveguide 900 is configured differently from the waveguide 800 of FIG. 8, to allow the input, and in-coupling of, of a single light field 955 rather than two separate light fields, such as an exit pupil from a single optical system.

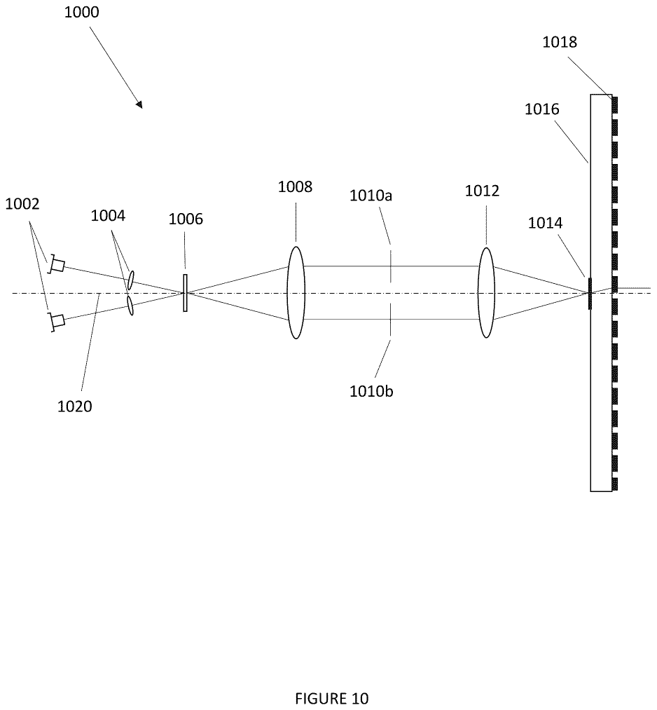

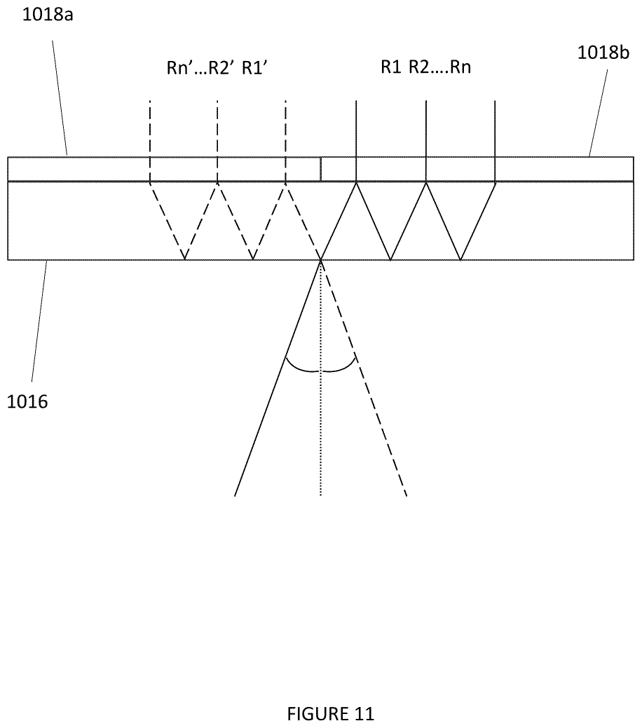

In particular, the input port 930 comprises a diffraction grating 960 at, in particular in front of (or upstream of), an aperture at the centre of the bottom, reflective surface 910. Diffraction grating 960 is arranged to turn the propagation direction of the optical path of an input light field into two optical paths (e.g., having equal and opposite directions) for waveguiding in first and second directions of the first dimension. Further details of the configuration of the diffractive grating 960 are provided below with reference to FIGS. 10 and 11A. In the illustrated example, a light field 955 is incident on the diffraction grating 960 at substantially normal incidence (i.e., an angle of incidence of zero degrees) in accordance with a first configuration. The diffraction grating 960 is a transmissive diffraction grating that is configured to form positive and negative first (and higher) diffraction orders at equal and opposite angles (e.g., with respect to the input angle or angle or incidence).

For example, a diffraction grating may form a zero order 0, which is un-diffracted light, and so is coupled into the waveguide at the same angle as the angle of incidence (i.e., normal incidence). In addition, the diffraction grating may form first positive and negative diffraction orders +1, −1 that are respectively coupled into the waveguide at the same first angle, but in opposite directions, and second positive and negative diffraction orders +2, −2, that are respectively coupled into the waveguide at the same second angle, but in opposite directions, wherein the second angle is greater than the first angle. As the skilled person will appreciate, higher diffraction orders may be formed by the diffraction grating.

The input light field 955 may be a holographic light field in some examples. For example, the input light field 955 is an exit pupil of a display device comprising spatially modulated light in accordance with a hologram displayed on the display device, as described herein. The hologram displayed on the display device may be relayed to the plane of the input port 930, or, more specifically, the plane of the diffraction grating 960. It may be said that the hologram forms the input wavefront coupled into the waveguide 900. Alternatively, it may be said that the input diffraction grating 960 is disposed at the plane of a hologram. In another example, the light field or wavefront corresponds to an image or picture formed on a surface such as a diffuse surface.

FIG. 9 shows a first order of the diffraction grating 960, comprising a positive primary diffraction order (e.g., positive first diffraction order) of the input light field 955 formed by the diffraction grating 960. The first order light is incident on the input port 930 (e.g., an aperture in bottom reflective surface 910) of waveguide 900 at a first input angle (or angle of incidence) θ, and is waveguided between the reflective bottom surface 910 and transmissive-reflective top surface 820 thereof in a first direction of the first dimension. A first one-dimensional array of replicas R1, R2, . . . Rn of the light field 955, extending in the first direction towards a first end 902 of waveguide 900, are formed and output at the transmissive-reflective output surface 920.

FIG. 9 additionally shows a second order, comprising a negative primary diffraction order (e.g., negative first diffraction order) of the input light field 955 formed by the diffraction grating 960. The second order light is incident on the input port 930 of the waveguide 900 at a second input angle (or angle of incidence) θ′, and is waveguided between the reflective bottom surface 910 and transmissive-reflective top surface 820 thereof in a second direction of the first dimension. A second one-dimensional array of replicas R1′, R2′, . . . Rn′ of the first light field 950, extending in the second direction towards a second end 902′ of waveguide 900, are formed and output at the transmissive-reflective output surface 920. As the skilled person will appreciate, the first input angle θ is equal in magnitude, and opposite in direction, to the second input angle θ′. Thus, the first and second one-dimensional arrays of replicas formed at the transmissive-reflective output surface 920 of waveguide 900 form a substantially continuous field of view. Furthermore, since the first and second one-dimensional arrays of replicas forming the complete, desired field of view replicate the same/identical unput light field 955 (e.g., the exit pupil of a single optical system) coupled into the waveguide 900, pupil expansion and image quality is optimised.

However, the use of a diffractive structure to propagate light in opposite directions may be problematic due to the wavelength-dependence of the diffractive turn. In other words, this can be problematic as different colours diffract at different angles resulting in different propagation paths in the waveguide (i.e. non-achromatic).

The present disclosure provides an alternative approach to central coupling into a waveguide that does not require an input diffractive structure.

### Dual-illumination Sources With a Shared SLM

FIG. 10 shows a schematic view of a dual-illumination optical system 1000 for central launch, according to the present disclosure.

Dual illumination sources 1002 emit light to illuminate a hologram displayed on spatial light modulator 1006. The dual illumination sources 1002 are configured to illuminate the SLM 1006 at respective angles of illumination measured, for example, relative to a central axis 1020 of the optical system 1000. The central axis 1020 may be parallel to a surface normal of the waveguide and/or a surface normal of the SLM 1006, for example. The light output from each of the sources 1002 is collimated by respective collimation lenses 1004 before illuminating the SLM 1006.

The light from each light source 1002 is therefore encoded with the hologram displayed on the SLM 1006, thus producing two wavefronts that may be referred to as holographic wavefronts.

The two wavefronts produced by each of the light sources 1002 are then received by a first lens 1008 of a 4f lens system. The first lens 1008 is positioned such that the SLM 1006 is located at an upstream focal plane of the first lens 1008. The two wavefronts are therefore imaged by the first lens 1008 such that intermediate images 1010a and 1010b are formed at a downstream focal plane of the first lens 1008. Due to the opposite angles of illumination for each light source 1002, the intermediate images 1010a and 1010b are formed spatially separated from one another. This spatial separation of the intermediate images 1010a and 1010b allows for the possibility of spatially filtering each intermediate image separately as an additional degree of design freedom. The intermediate images 1010a and 1010b may be spatially separated such that there is no overlap between them.

The two wavefronts continue to propagate through the 4f lens system and are received by the second lens 1012. The second lens 1012 is positioned such that the intermediate images 1010a and 1010b are located on the upstream focal plane of the second lens 1012. The second lens 1012 then focuses the two wavefronts to couple the light through the input port 1014 of the waveguide 1016.

The two wavefronts arrive at the input port 1014 at opposite angles of incidence due to their opposite angles of illumination, as described elsewhere herein. Once the wavefronts are coupled into the waveguide 1016, they propagate in opposite directions along an elongate dimension of the waveguide 1016 whereby they are reflected between opposing surfaces of the waveguide 1016, the replicas being transmitted at each bounce of the reflective-transmissive surface of the waveguide 1016.

The transmitted replicas are further diffracted by output diffractive structure 1018. The output diffractive structure 1018 is configured to apply a diffractive turn to the replicated wavefronts, for example to turn the replicas towards another waveguide for further replication along a second dimension.

FIG. 11 shows the coupling of two wavefronts (e.g. as produced by light sources 1002 in FIG. 10) into a waveguide 1016. As illustrated, each wavefront has an angle of incidence of equal magnitude, but in an opposite direction. Therefore, the wavefronts propagate along opposite directions of the waveguide to be replicated in an equal and opposite manner. In other words, the propagation of each wavefront is a mirror image of the other.

FIG. 11 also illustrates the output diffractive structure 1018 as having two sections 1018a, 1018b. Since the two wavefronts propagate in opposite directions along the waveguide 1016, the respective angle of incidence on the reflective-transmissive surface of the waveguide 1016 is also equal and opposite for the two wavefronts. Therefore, in order to turn the output light to the same final direction, the two sections 1018a, 1018b apply a diffractive turn by a different amount. In the example of FIG. 11, the diffractive turn applied by the two sections 1018a, 1018b are equal and opposite so that the output replicas are emitted perpendicular to the surface of the waveguide 1016. However, other configurations are contemplated, wherein the two sections 1018a, 1018b apply non-equal diffractive turn so that the replicas are emitted at a non-perpendicular angle from the surface of the waveguide.

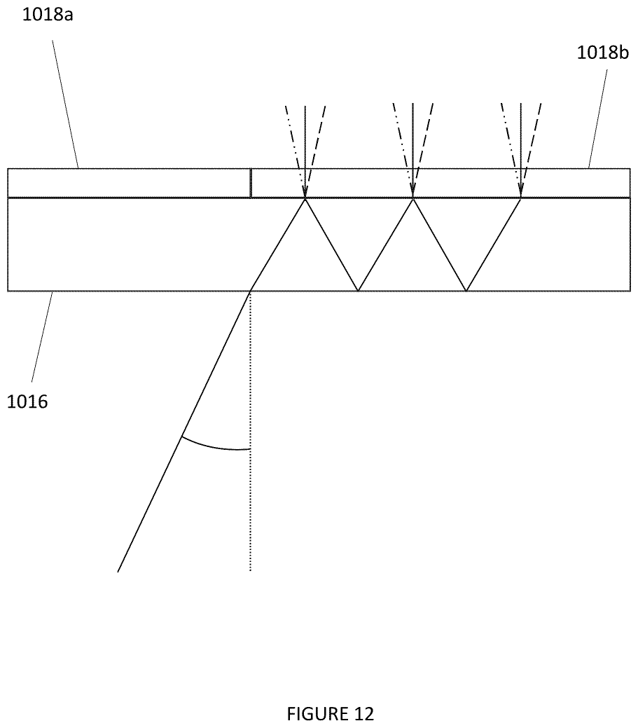

FIG. 12 shows the effect of chromatic dispersion associated with the diffractive turn of the output section 1018b. For the sake of clarity, only one wavefront (corresponding to one light source) is shown. In this example, the light source may comprise three different wavelength components. These different wavelength components may be provided by different laser diodes configured to output different wavelength light. In this comparative example, all three wavelength components share the same angle of incidence at the input port of the waveguide 1016, and therefore share the same angle of incidence at the reflective-transmissive surface of the waveguide. The output diffractive structure 1018b therefore turns each wavelength component by a different amount depending on the wavelength (i.e. according to Bragg's Law).

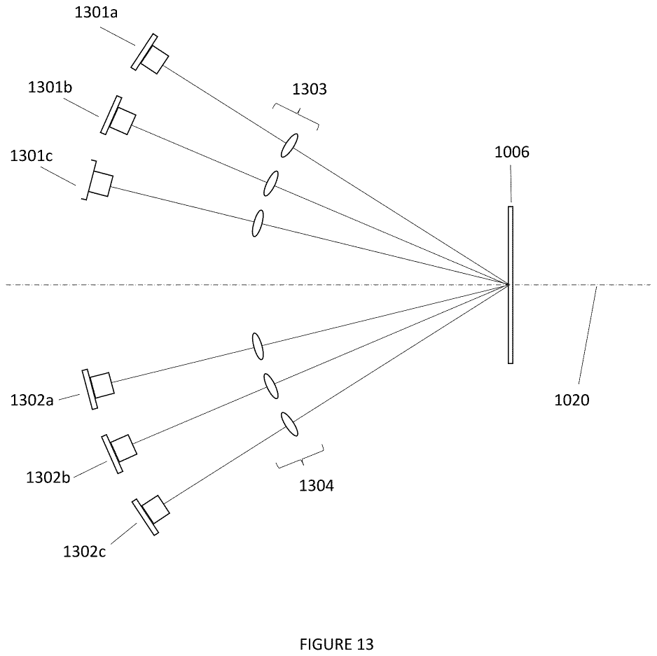

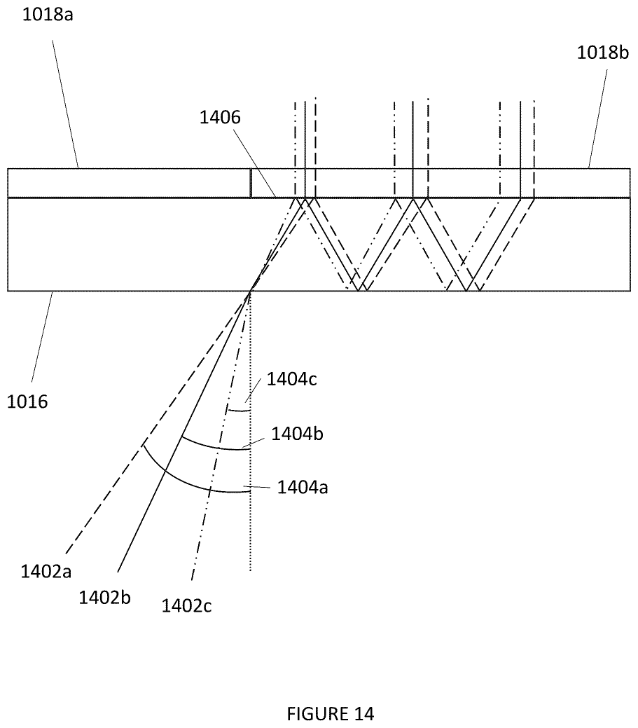

FIGS. 13 and 14 show an embodiment of the present disclosure whereby each of the two illumination sources may comprise a number of different sources corresponding to different colour light (i.e. each source may emit a different wavelength of light), wherein each illumination source 1002 of FIG. 10 may comprise a series of light sources such as lasers, e.g. a red laser, a green laser, and a blue laser. Each of these light sources are angled relative to one another such that each illuminates the SLM at a slightly different angle.

In particular, FIG. 13 shows two sets of light sources 1301a-c and 1302a-c. In this example, each set of light sources comprises three light sources configured to output different wavelength light, e.g. red, green, and blue light. For the first set of light sources, there is provided three light sources 1301a, 1301b, 1301c that are configured to illuminate the SLM 1006 at different angles with respect to the central axis 1020 (or normal of the surface of the SLM 1006), the magnitude of the angle depending on the wavelength emitted by the respective light source. The second set of light sources 1302a, 1302b, 1302c are arranged in substantially the same manner as the first set of light sources 1301a, 1301b, 1301c, but mirrored about the central axis 1020. That is, the magnitude of the angles of illumination for the second set of light sources 1302a, 1302b, 1302c are the same as the angles of illumination for the first set of light sources 1301a, 1301b, 1301c according to wavelength, but measured in the opposite direction from the central axis 1020.

Each of the light sources 1301a, 1302b, 1302c may have its own collimation lens 1303 before illuminating the SLM 1006, and each of the light sources 1302a, 1302b, 1302c may similarly have its own collimation lens 1304 before illuminating the SLM 1006.

FIG. 14 shows three wavefronts 1402a, 1402b, 1402c resulting from illumination of the SLM 1006 by a first set of light sources 1301a, 1301b, 1301c. Each wavefront is incident at the input port of the waveguide 1016 at different respective angles of incidence 1404a, 1404b, 1404c, the magnitude of each angle of incidence being selected based on the wavelength of the wavefront 1402.

Due to the different angles of incidence 1404a, 1404b, 1404c, the three wavefronts impinge upon the reflective-transmissive surface 1406 at different angles. Due to the different amount of diffractive turn applied by output diffractive structure 1018b, the different angles of incidence counteract this difference in diffractive turn such that the three (replicated) wavefronts exit the waveguide at the same angle. For example, in the illustration of FIG. 14 the wavefronts exit the waveguide perpendicular to the surface of the waveguide and parallel to each other. In other words, the angle of illumination for each wavelength is configured to control the angle of incidence and subsequently the angle at which the light is incident upon the output surface of the waveguide. For instance, if one wavelength component is turned more by the output diffractive element then the angle of illumination for that wavelength component may be configured so that the wavelength component is incident upon the output surface at a greater angle compared to another wavelength component that is turned less by the output diffractive structure. Therefore, the different wavelength components may exit the waveguide at substantially the same angle, i.e. substantially parallel to one another.

### Additional Features

The Following Numbered Example Are Disclosed Herein:

Example 1: An optical system comprising:
a waveguide comprising a pair of opposing surfaces arranged to guide light therebetween by internal reflection, the waveguide further comprising an input port arranged to receive light;
a spatial light modulator configured to display a light modulation pattern;
a first light source configured to output a first wavelength of light and configured to illuminate the spatial light modulator at a first angle of illumination to form a first wavefront;
a second light source configured to output a second wavelength of light different to the first wavelength, and configured to illuminate the spatial light modulator at a second angle of illumination different to the first angle of illumination to form a second wavefront; and
an output diffractive structure coupled to an output surface of the waveguide;
wherein the waveguide is configured to: (i) receive the first wavefront at the input port at a first angle of incidence, (ii) receive the second wavefront at the input port at a second angle of incidence, wherein the first angle of incidence and the second angle of incidence have a different magnitude, (iii) replicate the first wavefront along a first dimension in a first direction, and (iv) replicate the second wavefront along the first dimension in the first direction, wherein the first wavefront and replicas thereof and the second wavefront and replicas thereof are coupled out of the waveguide via the output diffractive structure.

Example 2: The optical system of Example 1, wherein the input port does not comprise a diffractive element.

Example 3: The optical system of any preceding Example, wherein the output diffractive structure is configured to perform a diffractive turn of the first wavefront and replicas thereof and the second wavefront and replicas thereof.

Example 4: The optical system of any preceding Example, wherein the first angle of illumination and second angle of illumination respectively determine the first angle of incidence and the second angle of incidence.

Example 5: The optical system of any preceding Example, wherein the first angle of incidence and the second angle of incidence are configured to counteract a difference in diffractive turn angle provided by the output diffractive structure to the first wavefront and replicas thereof and the second wavefront and replicas thereof.

Example 6: The optical system of Example 5, wherein the first wavefront and replicas thereof and the second wavefront and replicas thereof output from the output diffractive structure are substantially parallel to one another.

Example 7: The optical system of any preceding Example, further comprising a first collimating lens configured to receive light emitted from the first light source and to illuminate the spatial light modulator with collimated light at the first angle of illumination.

Example 8: The optical system of any preceding Example, further comprising a second collimating lens configured to receive light emitted from the second light source and to illuminate the spatial light modulator with collimated light at the second angle of illumination.

Example 9: The optical system of any preceding Example, further comprising a first lens with a first focal length, wherein the spatial light modulator is positioned at a first focal plane of the first lens.

Example 10: The optical system of Example 9, further comprising a second lens with a second focal length, wherein a first focal plane of the second lens is positioned to overlap a second focal plane of the first lens, and wherein the input port of the waveguide is positioned proximate to a second focal plane of the second lens.

Example 11: The optical system of any preceding Example, further comprising a third light source configured to output a third wavelength of light different to the first wavelength and second wavelength, and configured to illuminate the spatial light modulator at a third angle of illumination different to the first angle of illumination and second angle of illumination to form a third wavefront, wherein the waveguide is configured to receive the third wavefront at the input port at a third angle of incidence, wherein the third angle of incidence has a different magnitude to the first angle of incidence and the second angle of incidence.

Example 12: The optical system of any preceding Example, further comprising a fourth light source configured to output the first wavelength of light, and configured to illuminate the spatial light modulator at a fourth angle of illumination equal in magnitude and opposite in direction to the first angle of illumination.

Example 13: The optical system of any preceding Example, further comprising a fifth light source configured to output the second wavelength of light, and configured to illuminate the spatial light modulator at a fifth angle of illumination equal in magnitude and opposite in direction to the second angle of illumination.

Example 14: The optical system of Example 11, further comprising a sixth light source configured to output the third wavelength of light, and configured to illuminate the spatial light modulator at a sixth angle of illumination equal in magnitude and opposite in direction to the third angle of illumination.

Example 15: The optical system of any preceding Example, wherein the spatial light modulator is either transmissive or reflective.

Example 16: A method for holographic projection, comprising:
illuminating a spatial light modulator with a first light source at a first wavelength and at a first angle of illumination to form a first wavefront;
illuminating the spatial light modulator with a second light source at a second wavelength and at a second angle of illumination different to the first angle of illumination to form a second wavefront;
coupling the first wavefront into a waveguide at a first angle of incidence;
coupling the second wavefront into the waveguide at a second angle of incidence, wherein the first angle of incidence and the second angle of incidence have a different magnitude;
replicating the first wavefront along a first dimension of the waveguide in a first direction;
replicating the second wavefront along the first dimension of the waveguide in the first direction; and
coupling the first wavefront and replicas thereof and the second wavefront and replicas thereof out of the waveguide via an output diffractive structure.

Example 17: The method of Example 16, further comprising:
performing a diffractive turn of the first wavefront and replicas thereof and the second wavefront and replicas thereof with the output diffractive structure.

Example 18: The method of Example 16 or 17, further comprising:
configuring the first angle of incidence and the second angle of incidence to counteract a difference in diffractive turn angle provided by the output diffractive structure to the first wavefront and replicas thereof and the second wavefront and replicas thereof.
Example 19: The method of Example 18, wherein the first wavefront and replicas thereof and the second wavefront and replicas thereof output from the output diffractive structure are substantially parallel to one another.

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

What is claimed is:

1. An optical system comprising:
a waveguide comprising a pair of opposing surfaces arranged to guide light therebetween by internal reflection, wherein the waveguide further comprises an input port arranged to receive light;
a spatial light modulator configured to display a light modulation pattern;
a first optical element configured to illuminate the spatial light modulator at a first angle of illumination to produce a first wavefront;
a second optical element configured to illuminate the spatial light modulator at a second angle of illumination to produce a second wavefront;
wherein the waveguide is configured to:
receive the first wavefront at the input port at a first angle of incidence;
receive the second wavefront at the input port at a second angle of incidence, wherein the first angle of incidence is opposite in direction to the second angle of incidence;
replicate the first wavefront along a first dimension in a first direction; and
replicate the second wavefront along the first dimension in a second direction, wherein the first direction is opposite to the second direction in the first dimension.

2. The optical system of claim 1, wherein the input port does not comprise a diffractive element.

3. The optical system of claim 1, wherein the first angle of illumination is equal to the first angle of incidence, and wherein the second angle of illumination is equal to the second angle of incidence.

4. The optical system of claim 1, wherein the first optical element comprises a first collimating optics configured to illuminate the spatial light modulator with collimated light at the first angle of illumination.

5. The optical system of claim 1, wherein the second optical element comprises a second collimating optics configured to illuminate the spatial light modulator with collimated light at the second angle of illumination.

6. The optical system of claim 1, further comprising a first lens with a first focal length, wherein the spatial light modulator is positioned at a first focal plane of the first lens.

7. The optical system of claim 6, further comprising a second lens with a second focal length, wherein a first focal plane of the second lens is positioned to overlap a second focal plane of the first lens, and wherein the input port of the waveguide is positioned proximate to a second focal plane of the second lens.

8. The optical system of claim 6, wherein the first lens is configured to receive the first wavefront and to produce a first intermediate image at the second focal plane of the first lens, and wherein the first lens is further configured to receive the second wavefront and to produce a second intermediate image at the second focal plane of the first lens.

9. The optical system of claim 8, wherein the first intermediate image and the second intermediate image are spatially separated from one another.

10. The optical system of claim 1, further comprising
an output diffractive structure associated with an output port of the waveguide and configured to receive the replicated first wavefronts and replicated second wavefronts.

11. The optical system of claim 10, wherein the output diffractive structure comprises a first section configured to receive the replicated first wavefronts, and a second section configured to receive the replicated second wavefronts.

12. The optical system of claim 1, wherein each of the first optical element and second optical element further comprises:
a first light source configured to emit a first wavelength of light; and
a second light source configured to emit a second wavelength of light.

13. The optical system of claim 12, wherein the first light source is configured to illuminate the spatial light modulator at a first source angle of illumination, and wherein the second light source is configured to illuminate the spatial light modulator at a second source angle of illumination different than the first source angle of illumination.

14. The optical system of claim 13, wherein the first wavefront comprises a first sub-wavefront corresponding to the first light source and a second sub-wavefront corresponding to the second light source, and wherein the first sub-wavefront is received at the input port of the waveguide at a different angle of incidence than the second sub-wavefront.

15. The optical system of claim 12, wherein each of the first optical element and second optical element comprises:
a first collimating lens configured to illuminate the spatial light modulator with collimated light from the first light source at the first source angle of illumination; and
a second collimating lens configured to illuminate the spatial light modulator with collimated light from the second light source at the second source angle of illumination.

16. The optical system of claim 14, further comprising:
an output diffractive structure associated with an output port of the waveguide, wherein the angle of incidence of the first sub-wavefront corresponding to the first wavelength and the angle of incidence of the second sub-wavefront corresponding to the second wavelength are selected to counteract a difference in diffractive turn angle provided by the output diffractive structure to the first sub-wavefront and the second sub-wavefront.

17. The optical system of claim 1, wherein the spatial light modulator is one of transmissive or reflective.

18. A method for holographic projection, wherein the method comprises:
illuminating a spatial light modulator with a first optical element at a first angle of illumination to form a first wavefront;
illuminating the spatial light modulator with a second optical element at a second angle of illumination to form a second wavefront;
coupling the first wavefront into a waveguide at a first angle of incidence;
coupling the second wavefront into the waveguide at a second angle of incidence, wherein the first angle of incidence is opposite in direction to the second angle of incidence;
replicating the first wavefront along a first dimension of the waveguide in a first direction; and
replicating the second wavefront along the first dimension of the waveguide in a second direction, the first direction being opposite to the second direction.

19. Tangible, non-transitory computer-readable media comprising program instructions, wherein the program instructions, when executed by one or more processors, cause a holographic projection system to perform functions comprising:
illuminating a spatial light modulator with a first optical element at a first angle of illumination to form a first wavefront;
illuminating the spatial light modulator with a second optical element at a second angle of illumination to form a second wavefront;
coupling the first wavefront into a waveguide at a first angle of incidence;
coupling the second wavefront into the waveguide at a second angle of incidence, wherein the first angle of incidence is opposite in direction to the second angle of incidence;
replicating the first wavefront along a first dimension of the waveguide in a first direction; and
replicating the second wavefront along the first dimension of the waveguide in a second direction, the first direction being opposite to the second direction.

20. The tangible, non-transitory computer-readable media of claim 19, wherein the input port comprises a transparent window in a surface of the waveguide.
